(19) United States
(12) Patent Application Publication
(10) Pub. No.: US 2012/0020593 A1
(43) Pub. Date: Jan. 26, 2012

(54) Pull-Out Guide

(75) Inventors: Daniel Rehage, Bielefeld (DE); Stefan Salomon, Bielefeld (DE); Ruediger Brinkmann, Vlotho (DE); Glauco Piza, Curitiba (BR); Daniel Reidt, Herford (DE); Sven Budde, Luebbecke (DE)

(73) Assignee: Paul Hettich GmbH & Co. KG, Kirchlengern (DE)

(21) Appl. No.: 13/127,200

(22) PCT Filed: Oct. 29, 2009
(86) PCT No.: PCT/EP2009/064289

§ 371 Date: Sep. 29, 2011

(30) Foreign Application Priority Data
Nov. 3, 2008 (DE) 20 2008 014 564.3
Mar. 11, 2009 (DE) 20 2009 001 962.4

(51) Int. Cl. F16C 29/10; F16C 29/04

(52) U.S. Cl. 384/49; 384/54

(57) ABSTRACT

A pull-out guide, especially for household appliances, includes a guide rail and at least one additional rail which are mounted to be slidable relative to each other on sliding surfaces by way of rolling elements and which have at least one locking device for releasably fixing the additional rail in a predetermined position on the guide rail and/or on another additional rail. At least one locking device includes a spring element which can be make to engage with a profiled section or recess located at a distance from a sliding surface on a rail.

### BACKGROUND AND SUMMARY OF THE INVENTION

The present invention relates to a pull-out guide, especially for household appliances, comprising a guide rail and at least one additional rail which are mounted to be slidable relative to each other on sliding surfaces by means of rolling elements, and which have at least one locking means for releasably fixing the additional rail in a predetermined position on the guide rail and/or on a further additional rail.

A pull-out guide is shown in U.S. Pat. No. 3,039,838, in which two clamping walls are mounted in a U-shaped rail on an inside, in which a web can be inserted in a clamping manner. The attachment of the two wall sections and the production of the double-bent bracket is comparatively complex. Moreover, the clamping forces depend to a high extent on the tolerances.

DE 1 930 145 discloses a roller guide in which a latching apparatus is arranged. A recess is provided on a sliding surface of a reel which is partly penetrated by a ball. The ball is pretensioned upwardly by a spring towards the sliding surface. The ball is pressed downwardly when a roller rolls over the same, so that latching can occur. The latching by the roller comes with the disadvantage, however, that the running properties of the roller guide are impaired.

DE 3329541 discloses a pull-out guide for furniture, in which a recess is provided on an inside rail in the region of a guide groove for rolling elements. A form spring is inserted into the recess which can be compressed when rolling elements roll over the same. In this case too, latching of the rolling elements can occur, leading to unsteady running of the rails. Moreover, it can occur that the rolling elements impinge in a hard way on the form spring.

It is therefore the object of the present invention to provide a pull-out guide which enables latching of a rail in a predetermined position and comes with good running properties.

This object is achieved by a pull-out guide especially for household appliances, comprising a guide rail and at least one additional rail which are mounted to be slidable relative to each other on sliding surfaces by way of rolling elements, and which have at least one locking device for releasably fixing the additional rail in a predetermined position on the guide rail and/or on a further additional rail. The at least one locking device comprises a spring element which can be brought into engagement with a profiled section or recess on a rail, which profiled section or recess is spaced from a sliding surface.

In accordance with the invention, at least one locking device is provided on the pull-out guide, comprising a spring element which can be made to engage with a profiled section or recess located at a distance from a sliding surface on a rail. Locking can thus occur in a simple way, thus ensuring a controlled sequence control during opening and closing. The sequence control can be influenced in a purposeful manner by varying the spring forces.

In one embodiment of the invention, the at least one spring element is arranged between the running rail and the guide rail. The locking device can thus be integrated in the rail assembly, and therefore does not protrude perpendicularly to the longitudinal direction of the rails. Moreover, protection against soiling can be achieved, especially when the rails overlap one another in the retracted position and the locking device is covered. Such a protection of the locking device is advantageous for a long service life especially for household appliances, especially baking ovens.

In accordance with the invention, clamping occurs in the locking position by means of the spring element. The clamping force of the spring element can be arranged to be adjustable in a preferred embodiment, so that a releasable fixing is achieved, with the fixing being selectable in a stronger or weaker way depending on the load on the running rail. Especially in the case of baking ovens, a treatment of an item to be cooked can therefore occur in a prefixed position when the running rail is fixed in an extended position.

In a further embodiment of the invention, the running rail can be locked in a retracted position and in an extended position at a distance on the guide rail. In this way, the running rail can be fixed in the open or close position with item disposed thereon.

Preferably, a middle rail is arranged as an inner running rail between an outer running rail and the guide rail, which middle rail is displaceably held via first rolling elements on the running rail and second rolling elements on the guide rail. As a result, the outer running rail can be displaced within the terms of a fully extendable pull-out guide or with 100%+ extension before the guide rail. The running rail can be locked in the middle rail preferably by way of a first locking device and the middle rail can be locked on its part via a second locking device on the guide rail. This leads to a step-by-step sequence control, with the running rail being lockable in several mutually spaced positions. The middle rail can be locked in the guide rail in a retracted position and in an extended spaced position. Similarly, the running rail can be locked in the middle rail in a retracted and in an extended spaced position. When the running rail is pulled out, only the running rail is displaced relative to the middle rail at first until there is latching of the running rail in an end stop of the middle rail. Thereafter, the unit consisting of middle rail and running rail is moved relative to the guide rail until locking as been reached in an end stop in the extended position. Alternatively, the running rail can be displaced together with the middle rail during the pull-out until locking of the middle rail occurs in an end stop of the guide rail. The running rail is then moved relative to the middle rail until locking has been achieved in an end stop of the middle rail in the extended position. The user then feels the reaching of the end position by locking, with any inadvertent closing being prevented in the locked position as a result of the holding forces.

The locking device can preferably be a spring element with a bendable web, on which a projection can lock. The spring element can be fixed to a rail, with a bendable web being provided on opposite sides so that a spring element forms two locking means.

A ball, a roller or a slide element is provided on the spring element at the end for smooth locking.

In a further embodiment of the invention, the spring element cooperates with a recess in the rail. It can be produced easily, with a profiled section, especially a web-like projection, being embossed in the rail alternatively. The spring element is materially connected with the rail by gluing or welding. Alternatively, a mechanical fixing by means of a frictional or interlocking connection is also possible.

For a simple mounting of the locking device, they can be arranged integrally with the clip that can be clipped onto a rail which is inserted especially into a U-shaped receiver of the rail. External application of the clip is also possible. Profile sections can then be arranged on the rail in order to secure the clip against axial displacement.

### BRIEF DESCRIPTION OF THE DRAWINGS

The invention will be explained below by reference to several embodiments shown in the drawings, wherein:

FIGS. 1A to 1D show several views of a first embodiment of a pull-out guide in accordance with the invention;

FIGS. 2A to 2D show several views of a second embodiment;

FIGS. 3A to 3D show several views of a third embodiment;

FIGS. 4A to 4D show several views of a fourth embodiment;

FIGS. 5A to 5D show several views of a fifth embodiment;

FIGS. 6A to 6D show several views of a sixth embodiment;

FIGS. 7A to 7D show several views of a seventh embodiment;

FIGS. 8A to 8D show several views of an eighth embodiment;

FIGS. 9A to 14B show several views of rail sections for a pull-out guide in accordance with the invention; and

FIGS. 15 to 21 show several views of a further embodiment of a pull-out guide.

### DETAILED DESCRIPTION OF THE DRAWINGS

A pull-out guide 1 comprises a guide rail 2 which can be fixed to a side wall of a household appliance such as a baking oven, the furniture or any other component. A middle rail 3 is displaceably held on the guide rail 2 via rolling elements 5. A running rail 4 is displaceably held on the middle rail 3 via further rolling elements 5. The rolling elements 5 are held on rolling element cages 6 combined in packets.

One spring element 10 is provided on each opposite side on the middle rail 3. The spring element 10 is fixed with a section 11 to the middle rail 3, e.g. by welding, gluing or mechanical fixing means. The spring element 10 comprises a bendable web, on which a V-shaped projection 12 is arranged. As a result, an oblique run-up surface 14 and 15 is respectively arranged on opposite sides. The spring element 10 can latch with the V-shaped projection 12 into a rectangular recess 13 on the running rail 4 or a recess 16 in the guide rail 2. Other geometric shapes of the recesses 13, 16 are possible. The recesses 13 and 16 are arranged to be spaced from the sliding surfaces 7 for the rolling elements 5.

In the extended locked position, the projection 12 engages in a recess 13 in the running rail 4 or in a recess 16 in a guide rail 2. The middle rail 3 is moved relative to the running rail 4 or the guide rail 2 for unlocking, so that a run-up surface 14 or 15 comes into engagement with a wall and the projection 12 is lifted out of the recess 13 or 16. The spring element 10 can then slide with the projection 12 along the guide rail 2 of the running rail 4, with the sliding path of the projection 12 and the recesses 13 and 16 being arranged to be spaced from the running tracks 7 for the rolling elements 5.

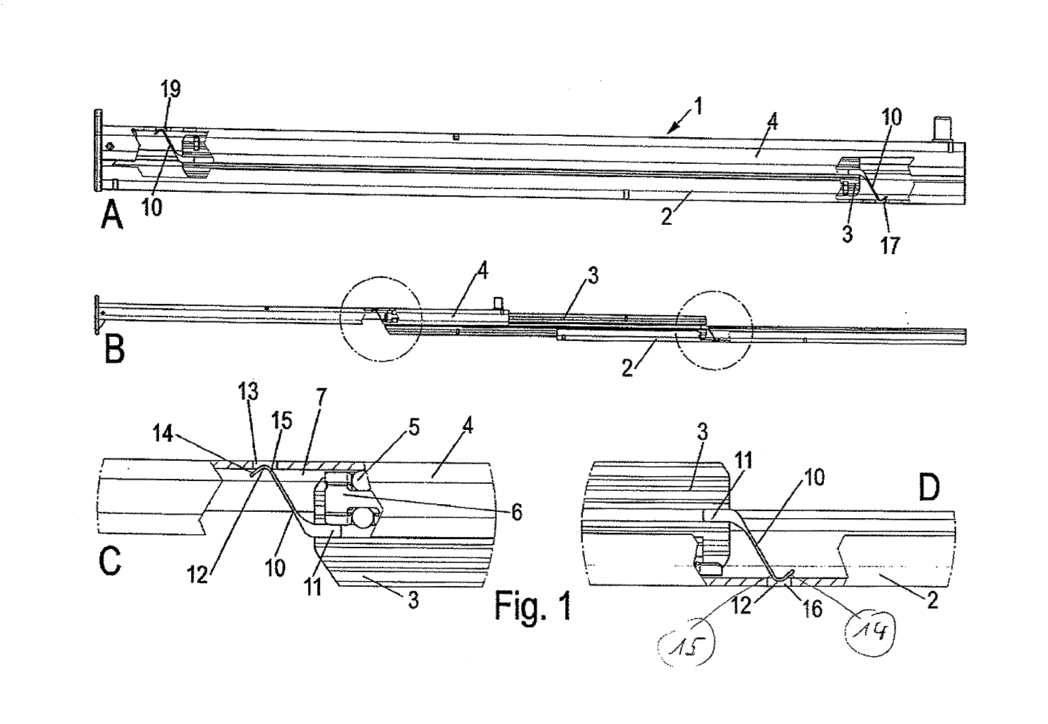

FIG. 1A shows the retracted locked position of the pull-out guide 1, in which the running rail 4 and the guide rail 2 cover the middle rail 3 with the two spring elements 10, so that the spring elements 10 are arranged to be protected. In the retracted position, one spring element 10 is latched into a recess 17 in the guide rail 2 and the other spring element 10 in a recess 19 in the running rail 4.

When the running rail 4 is extended, one spring element 10 is unlocked at first from the locked position and only the running rail 4 is moved at first relative to the unit consisting of middle rail 3 and guide rail 2 until a limit stop is reached and the spring element 10 latches into the recess 13 on the running rail 4. Thereafter, the middle rail 3 is moved together with the running rail 4 relative to the guide rail 2 until a limit stop is reached in this case too and the spring element 10 is locked in the recess 16 in the middle rail 3. Alternatively, the running rail 4 can be displaced together with the middle rail 3 during the pulling out process until there is a latching of the middle rail 3 in a limit stop of the guide rail. Thereafter, the running rail 4 is moved relative to the middle rail 3 until a latching has been achieved in a limit stop of the middle rail 3 in the extended position. This step-by-step extension of the pull-out guide 1 leads to a controlled sequence control, with the running rail 4 being lockable in three mutually spaced positions in the guide rail 2.

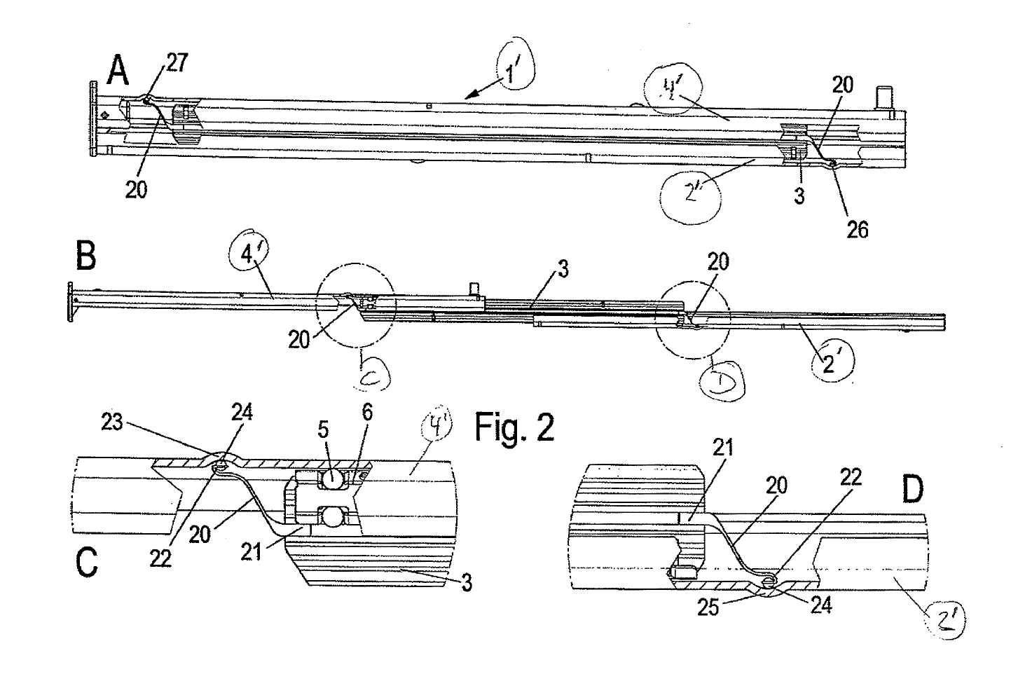

FIGS. 2A to 2D show a modified embodiment of a pull-out guide 1′, in which one spring element 20 each is fixed at opposite sides to the middle rail 3. Each spring element 20 is fixed with one section 21 to the middle rail 3 and comprises a bendable web. A fixing device 22 with a ball 24 is provided at the end side on the bendable web of the spring element 20. The ball 24 can be locked in trough-shaped embossed portions 23, 25, 26 and 27. The sequence of movement occurs as in the preceding embodiment.

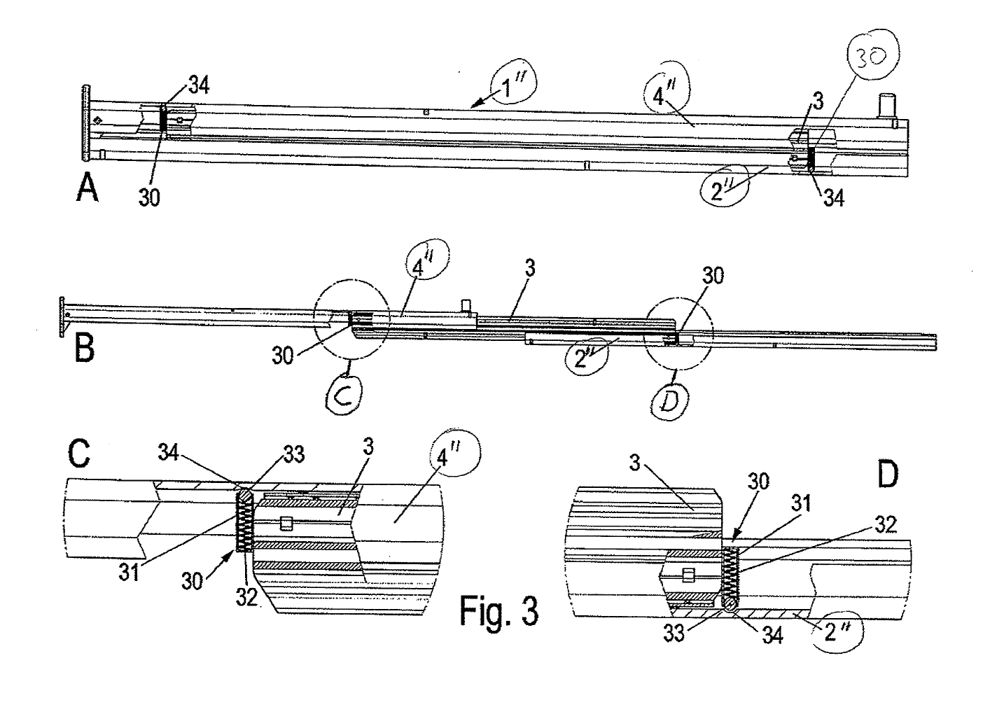

FIGS. 3A to 3D show a further embodiment of a pull-out guide 1″, comprising a guide rail 2″, a middle rail 3 and a running rail 4″. One spring elements 30 each is provided in this pull-out guide, which is mounted on opposite end sides of the middle rail 3. Each spring element 30 comprises one housing 31 which is arranged in the manner of a sleeve and is fastened to the middle rail 3. A pressure spring 32 is arranged in the housing 31, which spring is supported on one side on a floor of the housing 31 and on the opposite side on a ball 33. The ball 33 is secured against slipping out of the housing 31. For the purpose of locking of the spring element 30, the pretensioned ball engages in an embossed portion 34 on the running rail 4″ or the guide rail 2″. In this embodiment too, the running rail 4″ can be locked in three mutually spaced positions via the spring element 30.

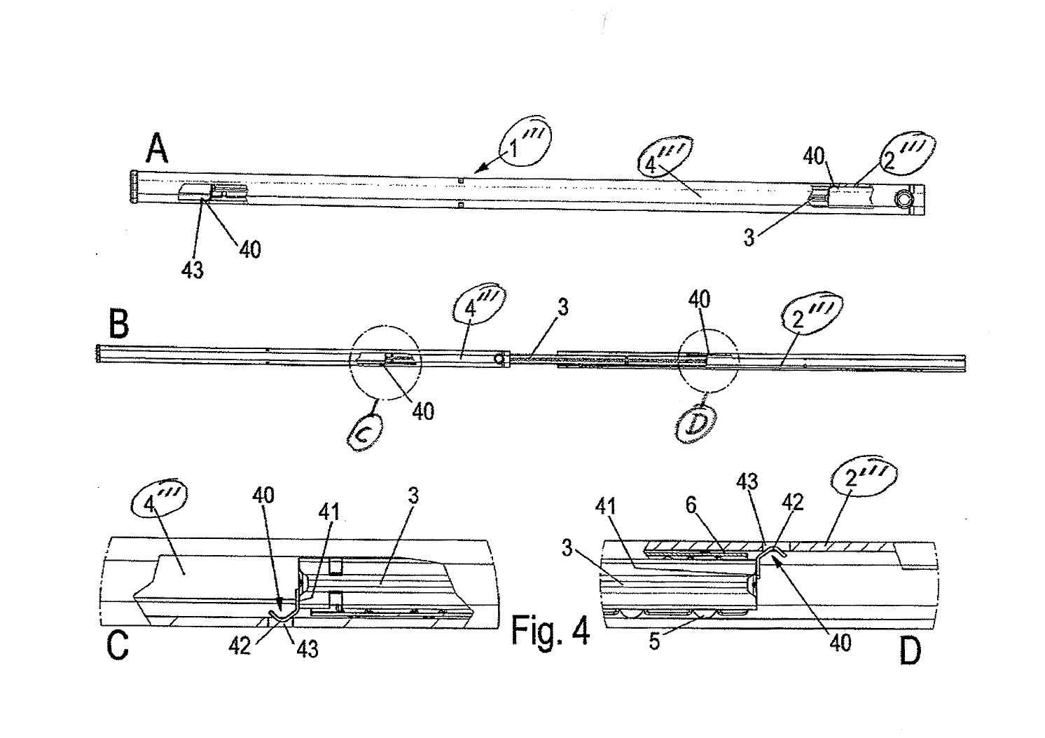

FIGS. 4A to 4D show a fourth embodiment of a pull-out guide 1″′, in which a spring element 40 is provided for locking the middle rail 3 on the running rail 4″′ with the guide rail 2″′. The spring element 40 comprises a web-like section 41 which is fixed at the end side to the middle rail 3. A V-shaped projection 42 with inclined run-up surfaces is further arranged on the spring element 40, with the V-shaped projection 42 being lockable in respective recesses 43 in the running rail 4″′ or the guide rail 2″′.

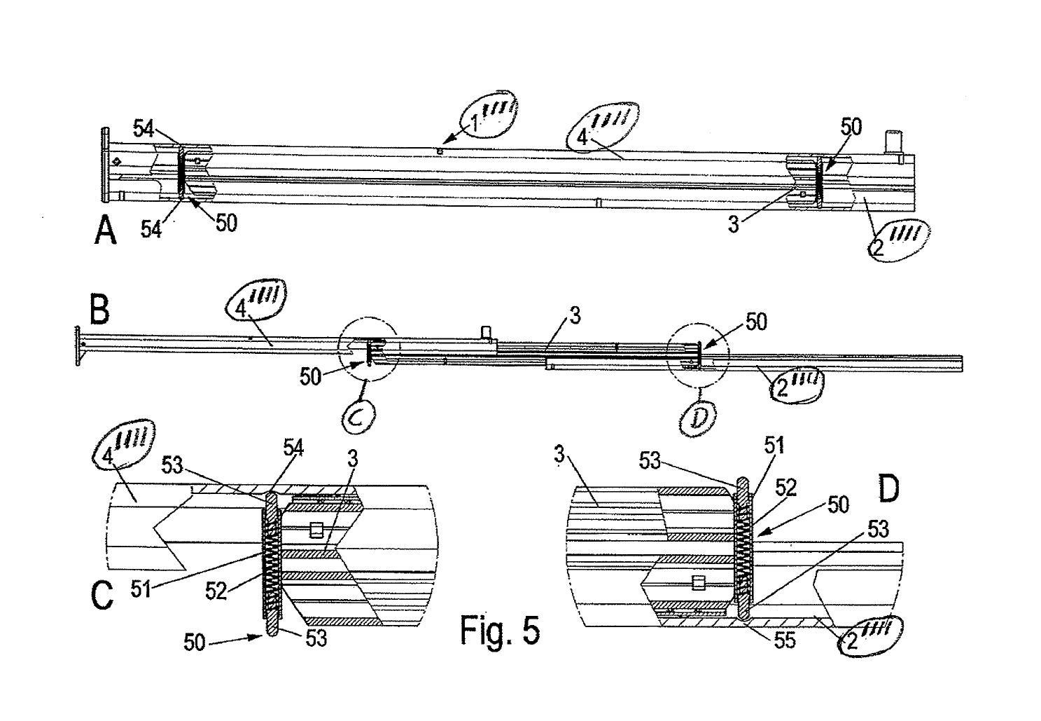

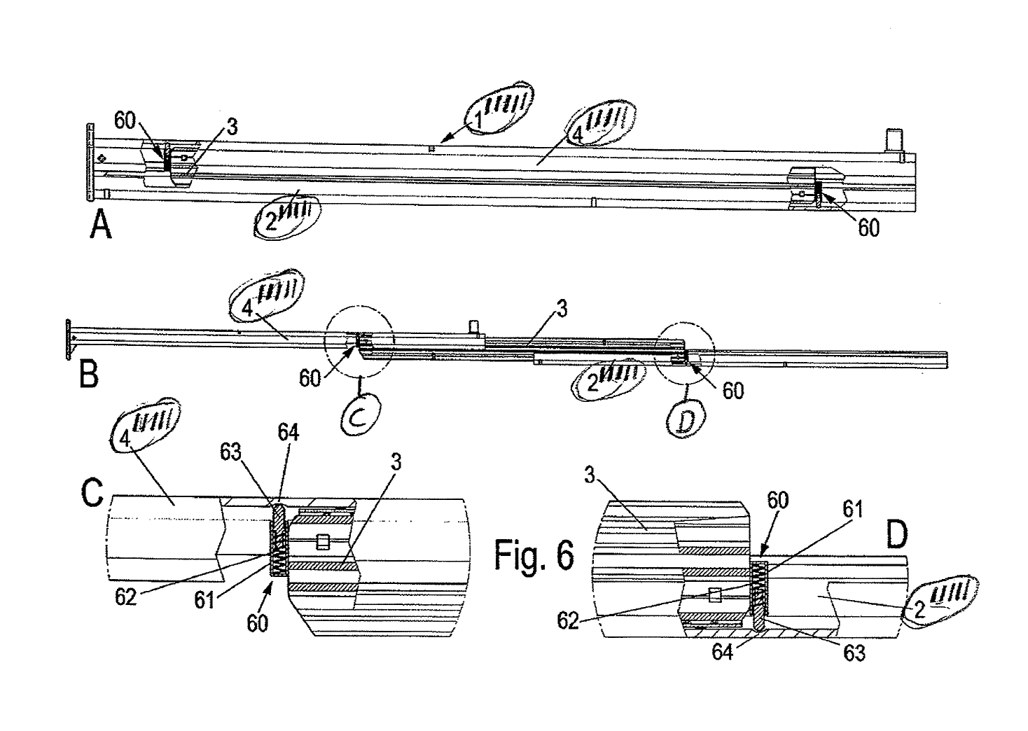

FIGS. 5A to 5D show a fifth embodiment of a spring element 50 which is fixed at the end side to the middle rail 3. The spring element 50 comprises a tubular housing 51 which is fixed to the middle rail 3, with a pressure spring 52 being arranged in the housing 51. The pressure spring 52 rests on opposite sides on a displaceable piston 53 which is secured against falling out by a stop in the housing 51. Piston 53 can be pushed into housing 51 against the force of the pressure spring 52. As a result, the piston 53 can latch into respectively arranged trough-shaped embossed portions 54, 55 in the running rail 4″″ or the guide rail 2″″. The arrangement of the spring element 50 in such a way that an engagement of a displaceable piston 53 is achieved simultaneously with the running rail 4″″ and the guide rail 2″″ on one side of the middle rail 3 allows double locking of the running rail 4″″ in the inwardly pushed position, since the running rail 4″″ is held in the inwardly pushed position via two locking means in the middle rail 3, and the middle rail 3 is also held via two locking means in the guide rail 2″″. In the extended position, the running rail 4″″ is locked in the middle rail only on one spring element 50.

FIGS. 6A to 6D show a further embodiment, in which a pot-shaped housing 61 with a pressure spring 62 is fixed at the end side to a middle rail 3 similar to the embodiment of FIGS. 3A to 3D, which pressure spring forms a spring element together with a displaceable piston 63. The piston 63 can be locked by the force of the pressure spring 62 in a trust-shaped embossed portion 64 in the running rail 4″″′ or the guide rail 2″″′.

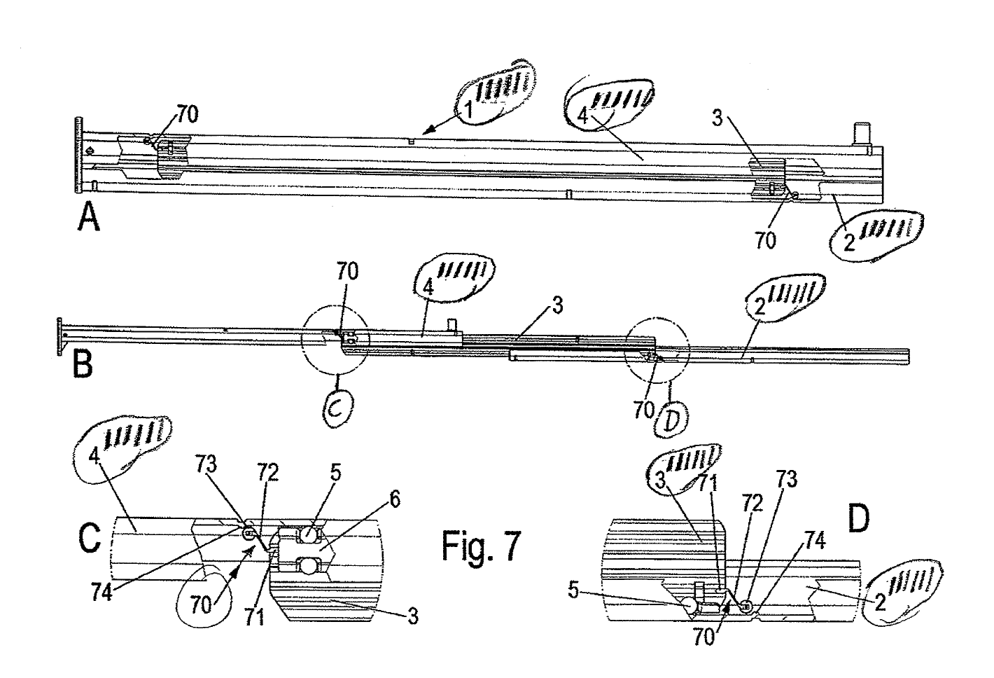

FIGS. 7A to 7D show a further embodiment of a pull-out guide 1″″″, in which one spring element 70 each is fixed at the end side to a middle rail 3. The spring element 70 comprises a section 71 which is fastened to the middle rail 3 by welding, gluing or any other way. The spring element 70 further comprise a bendable web 72, at the end of which a roll 73 is held. The roll 73 can also be arranged as a sliding element. When the spring element 70 is moved, it can be locked in a projection 74 on the running rail 4″″″ or the guide rail 2″″″. Several projections 74 can also be provided along the running track of the roll 73 in order to enable locking in different positions.

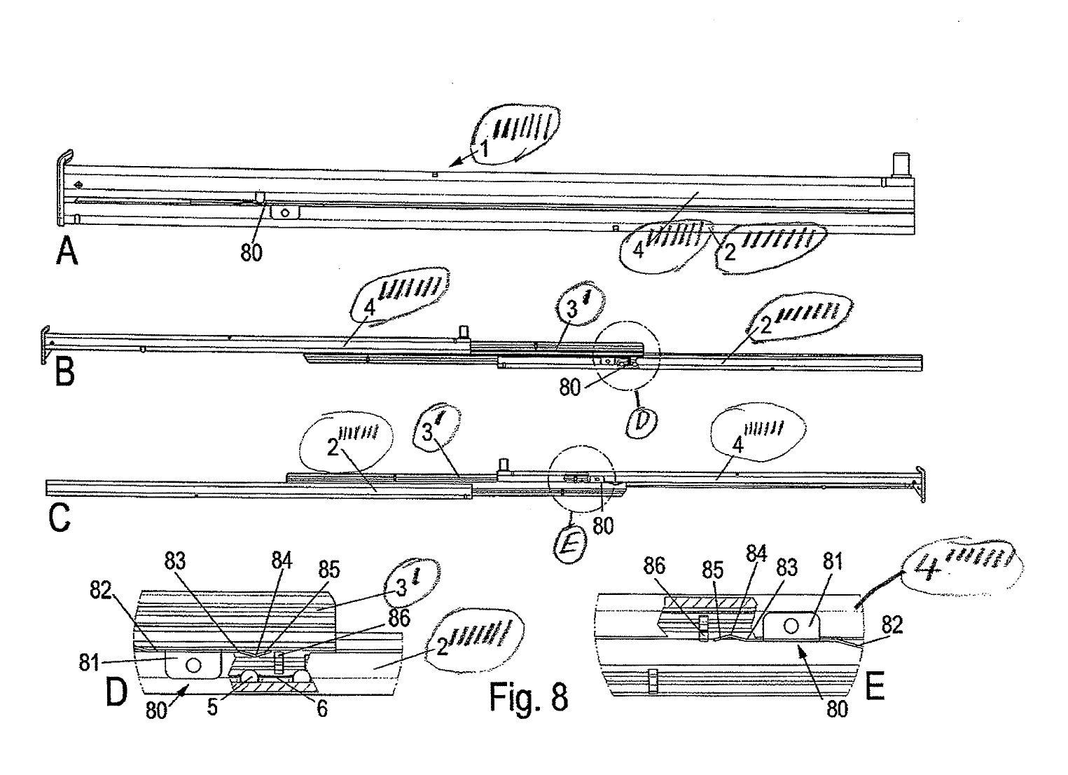

FIGS. 8A to 8E show an eighth embodiment of a pull-out guide, in which one spring element 80 each is fixed to the running rail 4″″″′ and guide rail 2″″″′. A profiled section arranged in the form of a projection 86 is disposed on the middle rail 3′. The spring element 80 comprises a tab 81 which is fixed to a sidewall of the running rail 4″″″′ or the guide rail 2″″″′. A web 82, 83 is provided on the tab 81 in a bent-off manner, which web projects on opposite sides of the tab 81, with a bendable V-shaped projection 84 being formed on each web 82 and 83, on which inclined run-up surfaces 85 are formed on opposite sides. The locking of the spring element 80 occurs in such a way that a profiled section in the form of a projection 86 slides over the elastic projection 84 and latches behind the V-shaped projection 84, with a limit stop being provided after moving over the V-shaped projection 84 which prevents further movement of the projection 86. In this embodiment, only the tab 81 is arranged outside of the interior space of the pull-out guide, whereas the bendable projections 84 are arranged in a protected manner between the guide rail 2″″″′ and the running rail 4″″″′.

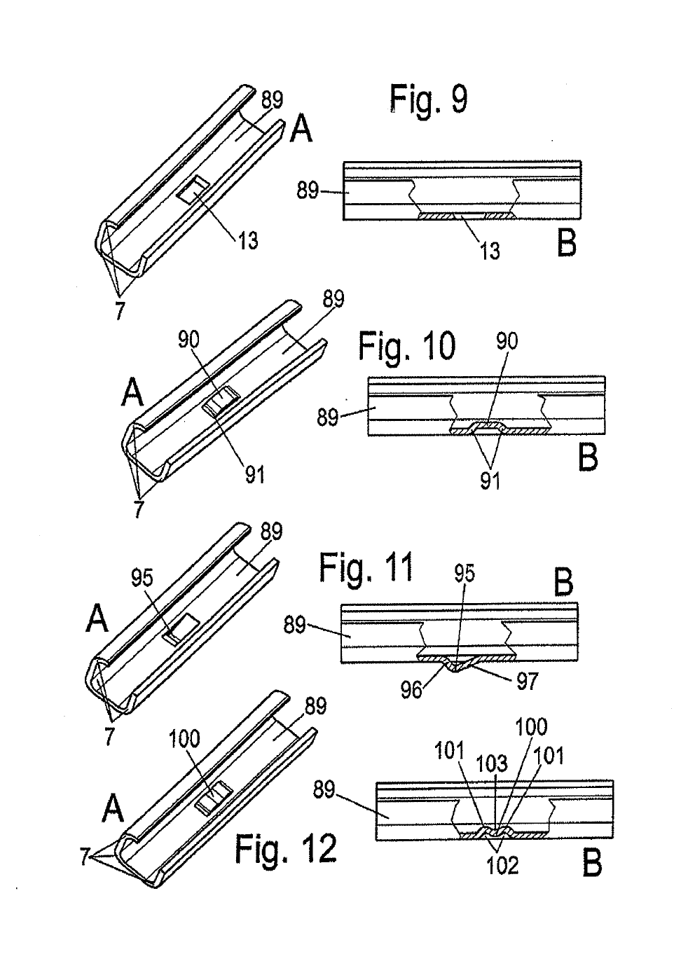

FIGS. 9 to 14 show different rail sections 89, which respectively show embossed portions or profiled sections which can cooperate with the aforementioned spring elements 10, 20, 30, 40, 50, 60, 70, 80. The rail section 89 can respectively be a component of the guide rail 2 to 2″″″′, the middle rail 3 and/or the running rail 4 to 4″″″′. Sliding surfaces for rolling elements 5 are arranged on each rail section 89, with the embossed portions and the profiled sections being provided at a distance from these sliding surfaces 7.

In FIGS. 9A and 9B, a rectangular recess 13 is provided between two sliding surfaces 7.

In FIGS. 10A and 10B, an embossed portion 90 is formed instead of a recess, which embossed portion is formed by a web which comprises inclined run-up surfaces 91 on opposite sides, so that a projection is formed on one inside and a depression on one outside.

A projection 95 is provided between two sliding surfaces 7 in the rail section 89 as shown in FIGS. 11A and 11B, which projection protrudes to the outside so that a V-shaped depression is formed on the inside. The depression is formed asymmetrically because the limbs 96 and 97 of the projection 95 have different lengths.

In the embodiment as shown in FIGS. 12A and 12B for a rail section 89, an embossed portion 100 is provided which protrudes towards the inside of the rail section 89 and comprises two spaced projections 101, between which a trough 103 for latching is provided. Two mutually spaced depressions 102 are arranged on the outside.

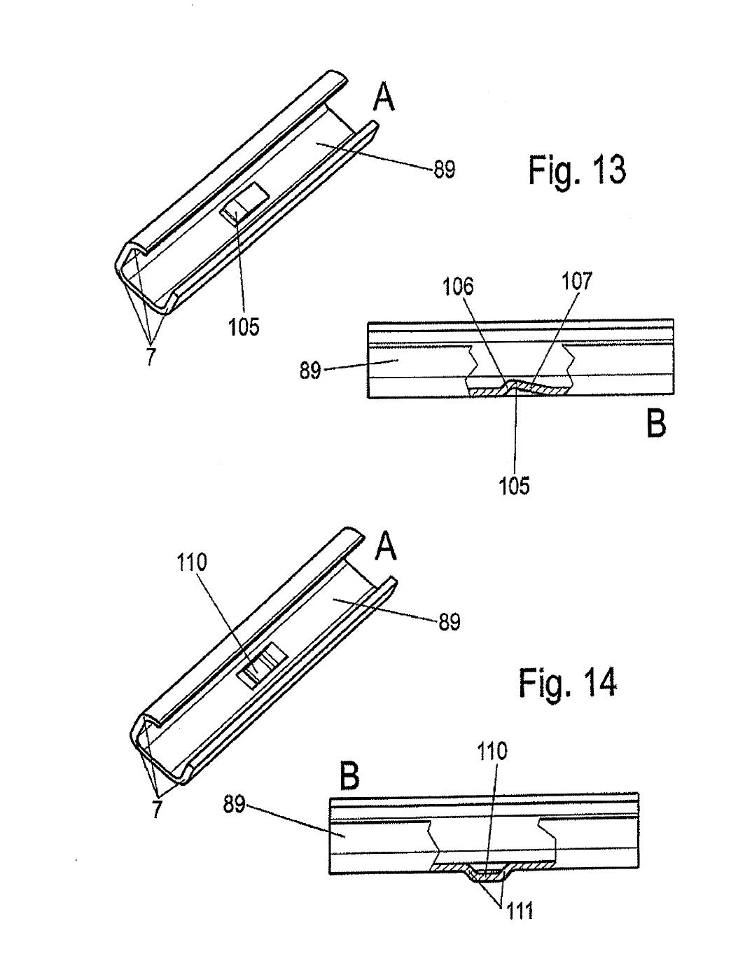

In the embodiment as shown in FIGS. 13A and 13B, an inwardly protruding embossed portion 105 is formed, which embossed portion is shaped in the manner of a web with differently long limbs 106 and 107. The limbs 106 and 107 are aligned at a different angle relative to the longitudinal axis of the rail section 89.

FIGS. 14A and 14B show a rail section 89 in which an outwardly protruding embossed portion 110 is provided which is arranged symmetrically and forms inclined run-up surfaces 111 on opposite sides.

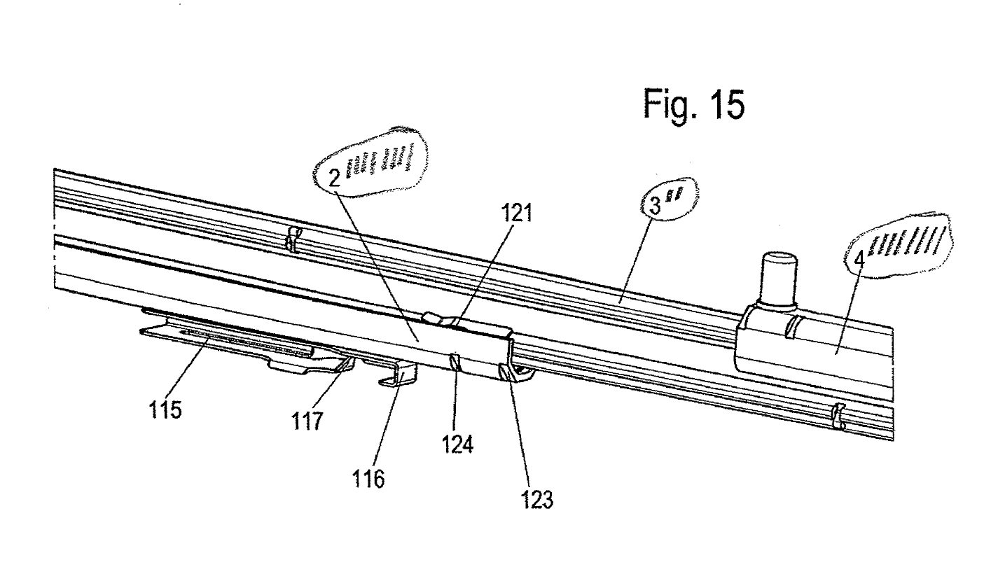

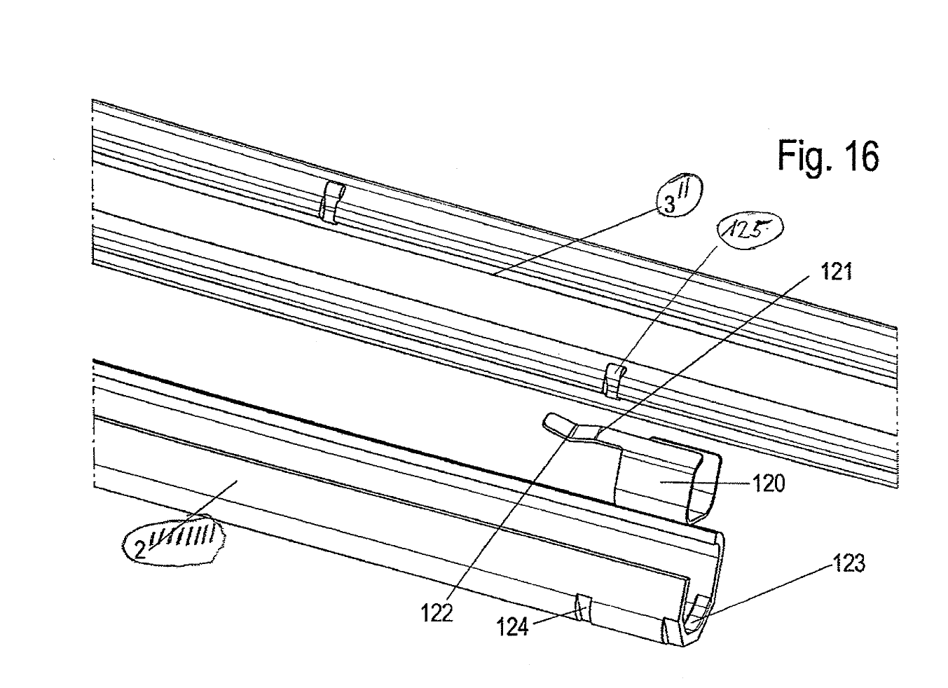

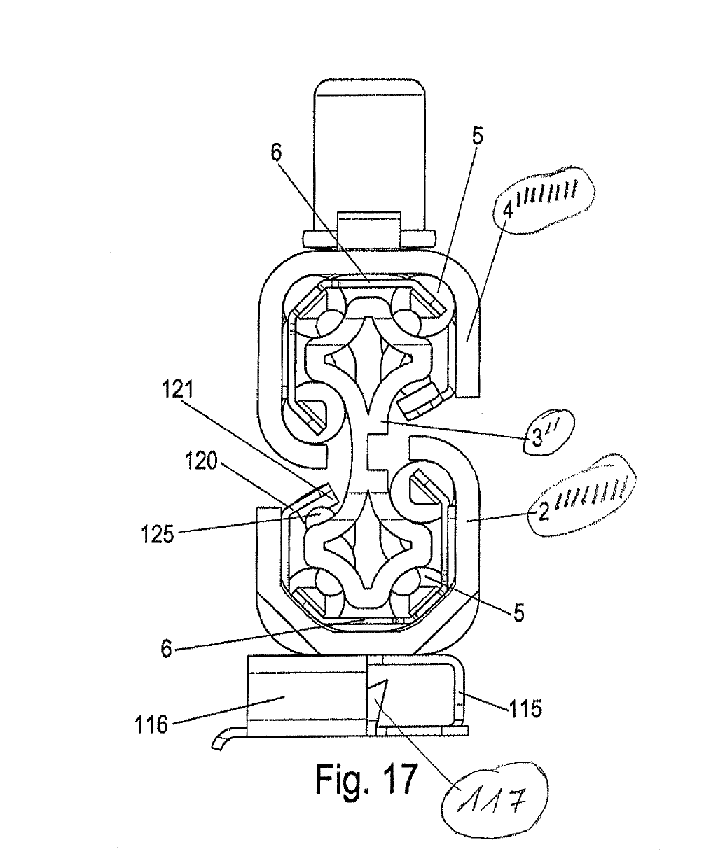

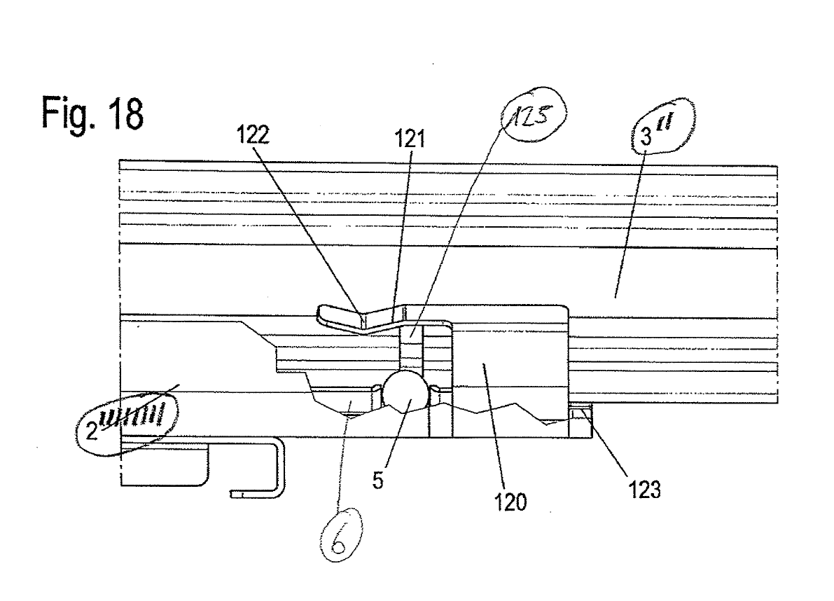

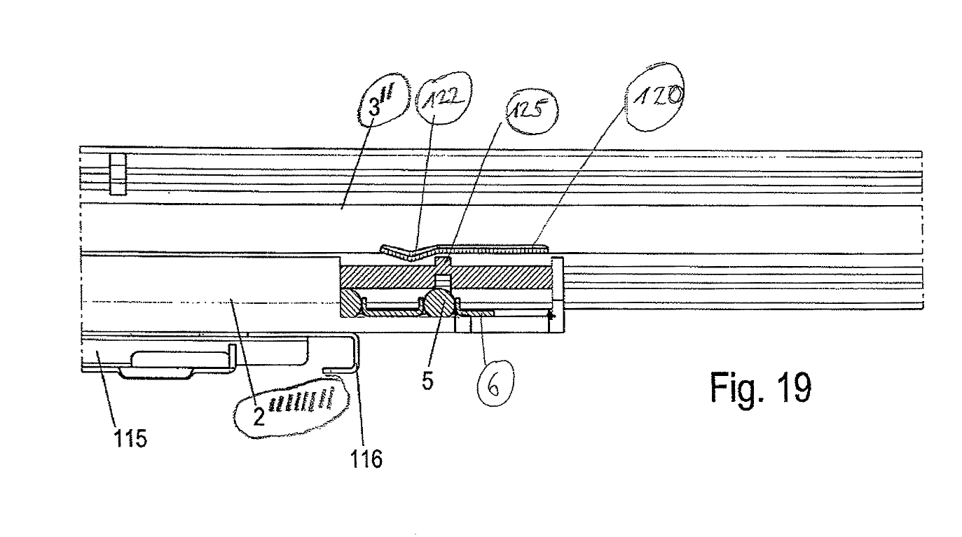

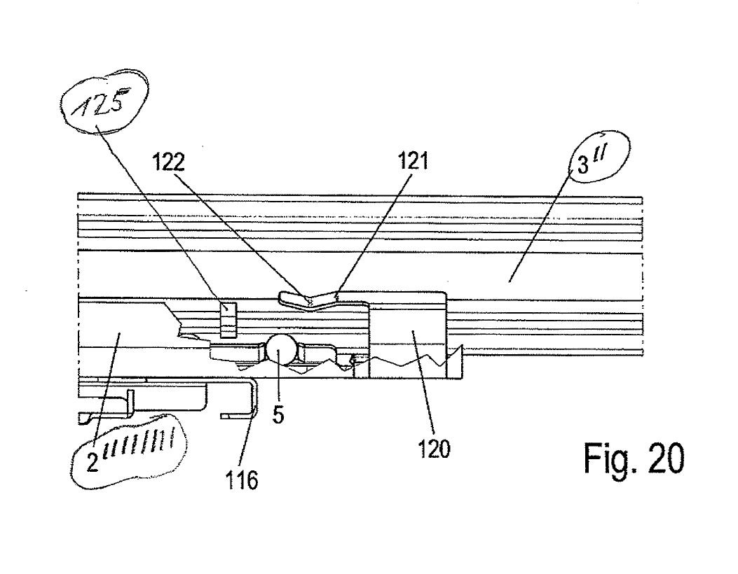

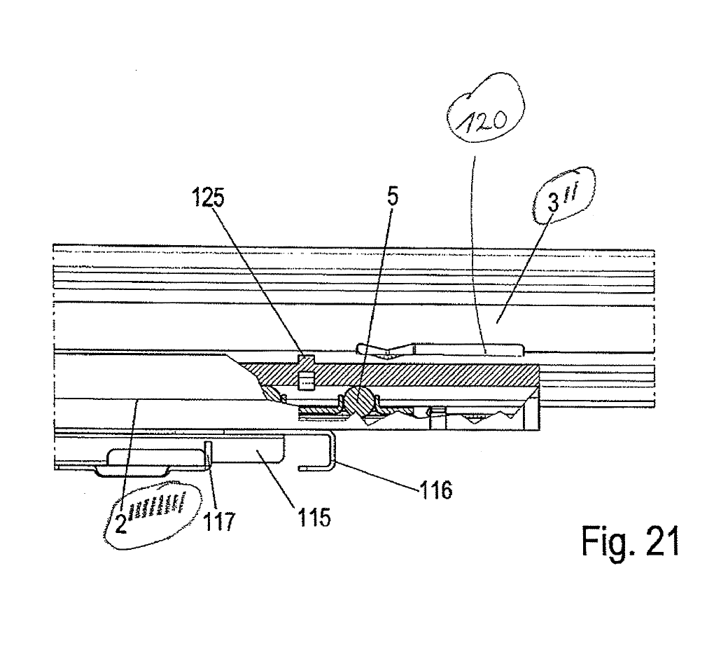

FIGS. 15 to 21 show a further pull-out guide, in which a clip 120 has been inserted on a guide rail 2″″″″ which is U-shaped in its cross-section, which clip is also U-shaped in its cross-section. The clip 120 comprises an integrally arranged web 121, on which a bend 122 is formed, so that the web 121 has a substantially V-shaped contour. In order to secure the clip 120 in the axial direction against displacement, two inwardly protruding profiled sections 123 and 124 are formed on the guide rail 2″″″″ which forms a stop for the clip 120.

The web 121 with the protruding bend 122 cooperates with a projection 125 which is formed on a middle rail 3 of the pull-out guide. When the projection 125 is driven over, the web 121 is swiveled, so that the middle rail 3″ will subsequently latch onto the clip 120.

The clip 120 is mounted on the inside in the guide rail 2″″″″. It is also possible to insert the clip 120 on the outside on the guide rail 2″″″″. Furthermore, further clips 120 can be simply mounted on the guide rail 2″″″″ and/or on the running rail 4″″″″ in a similar manner.

A retaining clip 115 is further fixed on one bottom side to the guide rail 2″″″″, which retaining clip comprises a U-shaped receiver 116 extending perpendicularly to the longitudinal axis. A bendable web with a projection 117 is arranged on the retaining clip 115, which web is used for locking the retaining clip 115 on a horizontal bar, especially a bar on a side grating, as are mounted in baking ovens for example.

The embodiments each show three rails which form a pull-out guide. It is naturally also possible to provide a pull-out guide with two or more than three rails which can be locked in different positions via one or more spring elements. The number of the spring elements is chosen in such a way that the pull-out guide is optimized for the respective application.

### LIST OF REFERENCE NUMERALS

1 Pull-out guide
1′ Pull-out guide
1″ Pull-out guide
1″′ Pull-out guide
1″″ Pull-out guide
1″″′ Pull-out guide
1″″″ Pull-out guide
1″″″′ Pull-out guide
1 ″″″″ Pull-out guide
2 Guide rail
2′ Guide rail
2″ Guide rail
2″′ Guide rail
2″″ Guide rail
2″″′ Guide rail
2″″″″ Guide rail
2″″″′ Guide rail
2″″″″″ Guide rail
3 Middle rail
3′ Middle rail
3″ Middle rail
4 Running rail
4′ Running rail
4″ Running rail
4″′ Running rail
4″″ Running rail
4″″′ Running rail
4″″″ Running rail
4″″″′ Running rail
4″″″″ Running rail
5 Rolling element
6 Rolling element cage
7 Sliding surface
10 Spring element
11 Section
12 V-shaped projection
13 Rectangular recess
14 Run-up surface
15 Run-up surface
16 Recess
17 Recess
19 Recess
20 Spring element
21 Section
22 Fixing device
23 Embossed portion
24 Ball
26 Embossed portion
27 Embossed portion
30 Spring element
31 Housing
32 Pressure spring
33 Ball
34 Embossed portion
40 Spring element
41 Web-like section
42 V-shaped projection
43 Recess
50 Spring element
51 Tubular housing
53 Displaceable piston
54 Trough-shaped embossed portion
55 Trough-shaped embossed portion
60 Spring element
61 Pot-shaped housing
63 Displaceable piston
64 Trough-shaped embossed portion
71 Section
72 Bendable web
73 Roll
74 Projection
80 Spring element
82 Web
83 Web
84 V-shaped projection
85 Inclined run-up surface
86 Projection
89 Rail section
90 Embossed portion
91 Inclined run-up surface
95 Projection
96 Limb
97 Limb
100 Embossed portion
101 Projection
102 Depression
103 Trough
105 Embossed portion
106 Limb
107 Limb
110 Embossed portion
111 Inclined run-up surface
115 Retaining clip
116 Receiver
117 Projection
120 Clip
121 Web
122 Bend
123 Profiled section
124 Profiled section
125 Projection

1-20. (canceled)

21. A pull-out guide for household appliances, comprising:
a guide rail;
at least one additional rail, the guide rail and the additional rail being slidably mounted relative to each other on sliding surfaces by way of rolling elements;
at least one locking device for releasably fixing the additional rail in a predetermined position on at least one of the guide rail and a further additional rail;
wherein the at least one locking device comprises a spring element which is engageable with a profiled section or recess on the guide rail, which profiled section or recess is spaced from a sliding surface.

22. The pull-out guide according to claim 21, wherein the at least one spring element is arranged between the additional rail and the guide rail.

23. The pull-out guide according to claim 21, wherein the at least one spring element is arranged between two additional rails.

24. The pull-out guide according to claim 21, wherein clamping in the locking position occurs by way of the spring element.

25. The pull-out guide according to claim 24, wherein the clamping force of the spring element is arranged to be adjustable.

26. The pull-out guide according to claim 21, wherein the at least one additional rail can be locked in the guide rail in a retracted position and in a spaced extended position.

27. The pull-out guide according to claim 21, wherein an outer running rail and a middle rail are provided between the running rail and the guide rail as additional rails, and the middle rail is displaceably held via first rolling elements on the running rail and via second rolling elements on the guide rail.

28. The pull-out guide according to claim 27, wherein the running rail is lockable via a first locking device on the middle rail, and the middle rail is lockable via a second locking device on the guide rail.

29. The pull-out guide according to claim 27, wherein the middle rail is lockable on the guide rail in a retracted position and in a spaced extended position.

30. The pull-out guide according to claims 27, wherein the running rail is lockable on the middle rail in a retracted position and in a spaced extended position.

31. The pull-out guide according to claim 27, wherein one spring element each is fixed at opposite end sides on the middle rail.

32. The pull-out guide according to claim 21, wherein the spring element comprises a flexible web, onto which a projection can latch.

33. The pull-out guide according to claim 32, wherein the spring element is fixed to a rail and a flexible web is provided on opposite sides.

34. The pull-out guide according to claim 21, wherein a ball or a sliding element is provided on the spring element at the end side.

35. The pull-out guide according to claim 21, wherein the spring element cooperates with a recess in a rail.

36. The pull-out guide according to claim 21, wherein the spring element is fixed to a rail by way of one of a material, a frictional, and an interlocking connection.

37. The pull-out guide according to claim 21, wherein the profiled section on the rail is arranged as a web-like projection with inclined run-up surfaces.

38. The pull-out guide according to claim 21, wherein the locking device is arranged integrally with a clip that can be latched into a rail.

39. The pull-out guide according to claim 38, wherein profiled sections are provided on the rail in order to secure the clip against axial displacement.

40. The pull-out guide according to claim 38, wherein profiled sections are introduced in the sliding surfaces of the middle rail which are not covered by the rolling elements.
